(19) United States
(12) Patent Application Publication
(10) Pub. No.: US 2003/0014183 A1
(43) Pub. Date: Jan. 16, 2003

(54) Data acquisition system

(76) Inventor: Paul John Feluch, Okotoks (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 09/901,894

(22) Filed: Jul. 11, 2001

(51) Int. Cl. G01C 21/26

(52) U.S. Cl. 701/200

(57) ABSTRACT

The invention relates to a data acquisition system for collecting and reporting production data from at least one production well. The system includes a data collection device operatively connected to one or more production data sensors on a production well, data collection device for storing and reporting production data to a computer.

### FIELD OF THE INVENTION

The invention relates to a data acquisition system for collecting and reporting production data from at least one production well. The system includes a data collection device operatively connected to one or more production data sensors on a production well, the data collection device for storing and reporting production data to a computer.

### BACKGROUND OF THE INVENTION

The collection of daily operating data from production wells is important to both monitor and optimize the efficiency of production. For example, operating parameters of the pumping system including rod torque, motor amps, and rod rpm of a progressive cavity pump as well as estimated fluid level, flow line pressure and flow are of importance to operators for increasing production, as well as lowering operating costs and down time of the wells in their control. This data is collected and analyzed on both a current and historical basis to make informed decisions with respect to managing production and maintenance.

At the present time, however, this process is inefficient in that oil companies or production service companies have operators drive around to individual wells to collect data for reporting to a central processing center at the company and/or to make adjustments to the production equipment based on current conditions or data collected the previous day. Typically, a company will have one or more operators drive to a series of geographically distributed wells to manually read and collect the current conditions data and make adjustments to the production equipment based on the current conditions or recommendations from the company office after analysis of previously collected data.

These data collection, analysis and adjustment processes are inefficient in different ways. For example, an operator will often spend considerable time travelling to different wells that besides collecting daily data from the well requires no analysis or adjustment to the production equipment. Accordingly, consideration time and expense is incurred as a result of the costs of the operator's vehicle and time. Furthermore, by travelling a fairly regular route between different wells and collecting data only once per day, data is not collected in real-time and, accordingly, the ability of a company to anticipate or recognize problem situations arising and react to them is reduced. Still further, the ability of the company to analyze data is limited by the accuracy of the data. That is, data that is manually transcribed and input into the company's database and analysis system will have a significant risk of transcription errors. Further still, if adjustments or maintenance are to be made to the wellhead based on the analysis of the wellhead data, the operator must travel to the wellhead to make the adjustment or conduct the maintenance with the disadvantage again of the attendant costs and time delay.

Accordingly, there has been a need for a system which overcomes the above problems and provides a system in which data can be efficiently collected and analyzed from a number of production wells without always requiring an operator to be present. Furthermore, there has been a need for a system wherein certain adjustments to the production equipment can be made without an operator being present.

### SUMMARY OF THE INVENTION

In accordance with the invention, there is provided a data acquisition system for collecting data from at least one production well comprising:

a data collection device operatively connected to well production equipment for obtaining production data from a well and for reporting the production data to a computer via a wired or wireless interface.

In another embodiment of the system, the computer is a central computer in operative connection with a plurality of data collection devices each connected to respective production wells.

In other embodiments, the data collection device includes a central processor operatively connected to an operator input system and a display system, the operator input system for receiving commands from an operator and the display system for displaying processed or unprocessed production data and/or the data collection device includes any one of or a combination of a digital or analog input/output device operatively connected to the central processor and wherein the digital and/or analog output devices are for operative connection to one or more production sensors or controls and/or the data collection device includes data storage memory operatively connected to the central processor for storing production data prior to uploading to the computer.

In further embodiments, the computer includes software having a central management module for managing the collection, analysis and reporting of production data from the data collection device and/or the central management module is operatively connected to a communication interface for sending and receiving data to and from the data collection device.

In a further embodiment, the central management module includes a control module for sending control instructions to the production controls through the data collection device.

In a more specific embodiment, a data acquisition system for collecting data from at least one production well is provided comprising:

a data collection device operatively connected to well production equipment for obtaining production data from a production well and for providing control instructions to the production equipment;

a central computer operatively connected to the data collection device for receiving production data from the data collection device and for sending control instructions to the production equipment via a wired or wireless interface wherein the central computer includes:

a central management module for managing the collection, analysis and reporting of production data from the data collection device;

a production data database;

a wired or wireless interface;

a reporting module for formatting reports from the production data database; and,

a graphical display module for displaying production data from the production data database

In a further still embodiment a method of collecting data from a production well is provided comprising the steps of:

a) operatively connecting a data collection device to well production equipment at a well; and,

b) uploading production data from the data collection device via a wired or wireless link to a central computer.

### BRIEF DESCRIPTION OF THE DRAWINGS

The invention will now be described by the following description and drawings wherein:

FIG. 1 is a schematic overview of the deployment of the system in accordance with one embodiment of the invention; and,

FIG. 2 is a schematic diagram of the hardware and software deployment of the system in accordance with one embodiment of the invention.

### DETAILED DESCRIPTION OF THE INVENTION

With reference to the Figures, a data acquisition system 10 is described providing enhanced data acquisition capabilities from at least one production well 12 and its associated production equipment 12a.

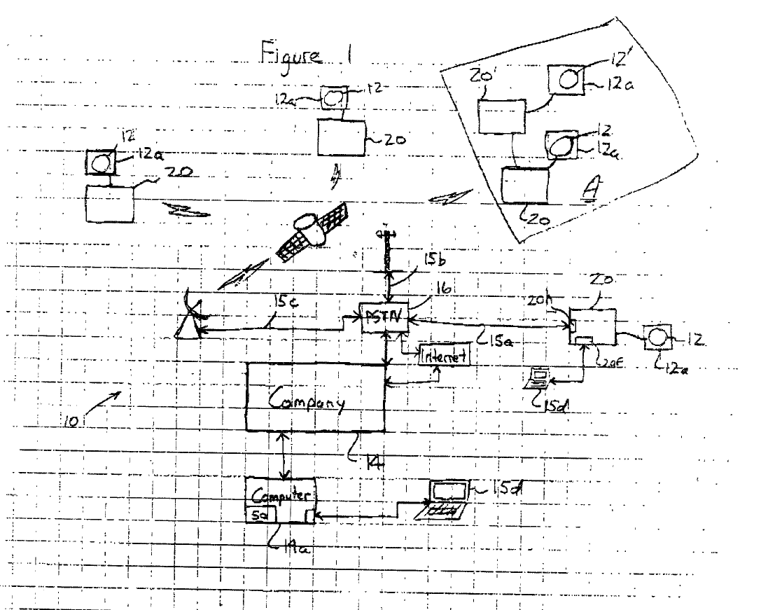

In one embodiment and as shown in FIG. 1, a plurality of geologically distributed production wells 12 each having production equipment 12a and a data collection device 20 are operatively connected to a central data collection center 14 and computer 14a via any one of a wired, wireless or manual link. As shown, a wired link includes wireline telephone 15a and wireless links may include cellular 15b, satellite 15b or other radio links as is known. Wired or wireless links may pass through a public switched telephone network PSTN) 16 or the internet. Data collected from the production well 12 may be transferred to the central computer 14a via the wired or wireless links 15a, 15b, 15c or may be manually transferred through portable computers 15d by an operator after downloading production data directly from data collection device 20 and uploading the data to the computer 14a. Furthermore, two or more data collection devices 20 as shown at location A in FIG. 1 may be connected to respective productions wells and may be connected to one another in order to communicate with the computer 14a via a common interface.

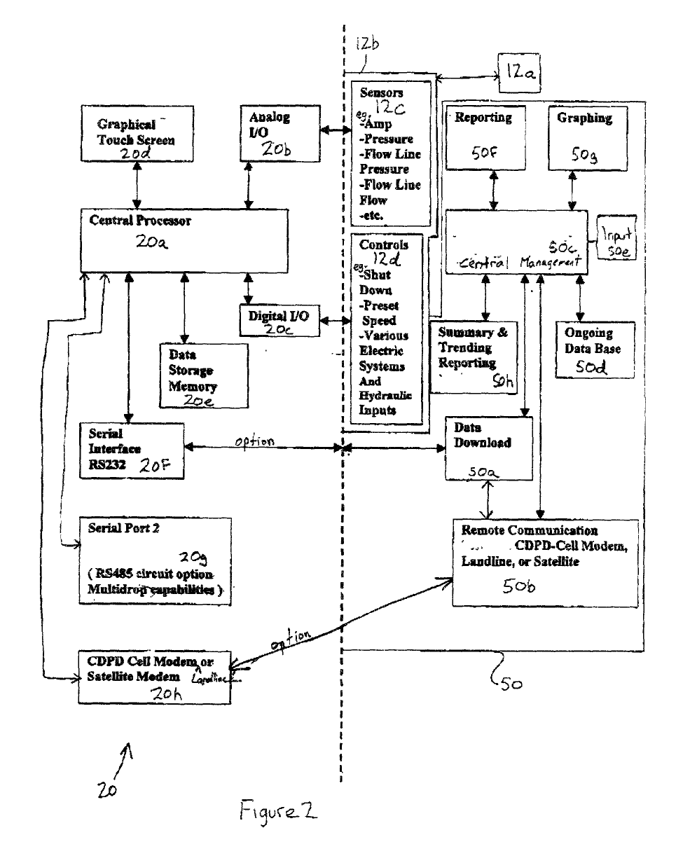

The hardware/software block diagram of the data collection system 10 is shown in FIG. 2. The hardware components of the device 20 are shown to the left of the dotted line and interface with the production equipment 12a through sensors/controls 12b and data processing/control software/hardware 50 on computer 14a and/or computer 15d.

The device 20 includes a central processor 20a providing overall control and management of the data collection and reporting functions of the device 20 to the computer 14a as well as control of the wellhead production equipment 12a. The central processor 20a is operatively connected to an analog input/output interface 20b for receiving and sending data to sensors 12c and to a digital input/output interface 20c for receiving and sending data to various production equipment controls 12d. Various sensors may include but are not limited to motor ampere, well pressure, flow line pressure or flow line flow sensors and production equipment controls may include shut switches, speed control or other electrical systems and/or hydraulic inputs.

The central processor 20a is further connected to a graphical touch screen 20d for displaying information to an operator and allowing operator input of data to the device 20 and to a data storage memory 20e for storing data from the production equipment sensors 12c and controls 12d

The central processor 20a is further connected to an interface 20f for receiving and providing data to and from data acquisition software 50 resident in a portable computer 15d. In one embodiment, the interface 20f is a serial interface using RS232 communication protocols.

The device 20, in alternate embodiments, may include another interface 20g for operative connection to another device 20′ in close geographic proximity to a first device 20 as shown at location A. Such a deployment is useful where two or more production wells are in close proximity to one another thereby enabling the data from each well to be reported via a single communication channel in order to reduce communication costs. As shown, individual devices 20 may include a RS485 interface and protocol.

Still further, the device may include a wireline, cell or satellite modem 20h for receiving and delivery of data over wireline, cellular or satellite communication channels.

The software 50 includes appropriate interface routines for receiving and sending data to and from the central computer 14a or a portable computer 15d. As shown in FIG. 2, software 50 may include data download module 50a for requesting data via serial interface 20f or modem 20h through modem module 50b. Both the data download module and modem module are operatively connected to a central management module 50c.

Central management module 50c receives data from a device 20 as described above and stores data in database module 50d. Appropriate input commands from input module 50e allow an operator to create specific reports from reporting module 50f, graphs from graph module 50g and/or summary and trending reports from summary and trending report module 50h.

Further still, in one embodiment, the central management module 50c enables the control of production equipment based on operator input at computer 14c or 15d or specific control algorithms within software 50. That is, specific control parameters of the production equipment may be altered based on pre-determined control algorithms or following analysis and input by an operator.

### EXAMPLE

By way of example, the device 20 enables multiple production parameters to be viewed easily on the graphical screen 20d at the well 12. Typical parameters may include rod torque, motor amps, rod RPM, estimated fluid level, flow line pressure and flow. The operator may select to view the data history from minutes to hours, multiple days, weeks or months.

Furthermore, the device 20 may also be used to start and stop or adjust the speed of the well based on high and low torque/amp settings. This allows onsite control of the well 24 hours a day. For example, a pumping system may have a torque setting of 1000 ft lb to protect the well with a typical operating torque of 500 ft lbs. Changes of + & −50 ft lbs would be significant, and can be countered using control algorithms or operator input prior to this event becoming an equipment-damaging problem and costing thousands of dollars to repair the production equipment with the resulting loss of production.

Typical fields of data (Torque, Amps, RPM, Estimated Fluid Level, Flow Line Pressure and Flow) are stored into memory 20e at a typical 12 bits resolution as well as any user changes, all settings, and the digital I/O activity. Data collection may proceed at user-determined intervals such as 5 minute samples. Further still, the device 20 may include a delta sample system for reporting high parameter value changes within pre-determined time-intervals. For example, if the Torque/Amps change by the delta value, indicating a drastic change, the sample rate will change to 1 second to catch the transient into memory and to optimize data capture.

In order to operate in the wide range of climatic conditions of a well 12, the device 20 will preferably include a −40 to +50 deg C. operating temperature,

### Typical Hardware & Software Platform

The typical hardware and software platform of the device will typically include:

Central Processor

Graphical LCD display 320×240

Touch screen and membrane keypad

hardware circuits as follows:

17C756 processor with built in 10 bit A to D's

I2C Flash memory

320×240 graphical LCD interface

Temperature compensating contrast circuit

Dual RS232 ports & optional RS485

Analog isolation amplifiers for 2 inputs and one output

RMS to DC conversion

+5 V, +/−12 V, and isolated +/−12 V Power Supplies

Digital I/O which include 2 dry relay contacts and 2 opto isolation inputs

I2C real time clock

I2C 8 bit A to D input and output

Frequency to Voltage converter

Touch Screen and Membrane Keypad Interface

Cell Modem (CDPD) interconnection

Control wiring and power input schematics for the various electric and hydraulic systems.

Intrinsically Safe RPM pickup

Outdoor Nema 4 enclosure with windowed door

Software algorithms for High and Low setpoint Control

Software configuration for the various Electric and Hydraulic I/O's

Log data being sampled and all user changes and settings

Software algorithm for calculating Estimated Fluid Level

RPM pickup counter

The software 50 will preferably enable or provide the following:

Window's based program with user friendly tabs and buttons

Data download from device in real-time and remotely

Data base handling of downloaded data, and ability to add on for an ongoing data file for every device 20

Ability to choose data to be graphed and selecting date and time span

Ability to enter a customer header on all graphs, and printing capability

View all data in reports and view all of the details and settings

Summary Report, based on weeks of operation, which include up and down time, operating time, amp or pressure trend calculation with percentage of confidence

Real time viewing of device activity, as well as remote data downloading using Cell Modems (CDPD), via the internet.

Upon deployment in the field, the system enables an oil company or production service company the flexibility to monitor and control a production well from either an on-site or remote location depending on the specific deployment circumstances. For example, a fully deployed system would enable a service company to remotely monitor and control a number of production wells across a wide area from a single location and deploy field personnel only upon specific events occurring at specific wells. Alternatively, in a partially deployed system, a service company may remotely monitor and control a number of wells while manually collecting data from other wells through the use of a portable computer. Such a partial deployment may be employed in view of communication costs and/or as a transition towards a full deployment.

We claim:

1. A data acquisition system for collecting data from at least one production well comprising:
a data collection device operatively connected to well production equipment for obtaining production data from a well and for reporting the production data to a computer via a wired or wireless interface.

2. A data acquisition system as in claim 1 wherein the computer is a central computer in operative connection with a plurality of data collection devices each connected to respective production wells.

3. A data acquisition system as in claim 1 wherein the data collection device includes a central processor operatively connected to an operator input system and a display system, the operator input system for receiving commands from an operator and the display system for displaying processed or unprocessed production data.

4. A data acquisition system as in claim 1 wherein the data collection device includes any one of or a combination of a digital or analog input/output device operatively connected to the central processor and wherein the digital and/or analog output devices are for operative connection to one or more production sensors or controls.

5. A data acquisition system as in claim 3 wherein the data collection device includes data storage memory operatively connected to the central processor for storing production data prior to uploading to the computer.

6. A data acquisition system as in claim 2 wherein the computer includes software having a central management module for managing the collection, analysis and reporting of production data from the data collection device.

7. A data acquisition system as in claim 6 wherein the central management module is operatively connected to a communication interface for sending and receiving data to and from the data collection device.

8. A data acquisition system as in claim 7 wherein the central management module includes a control module for sending control instructions to the production controls through the data collection device.

9. A data acquisition system as in claim 2 wherein the data collection device includes a central processor operatively connected to an operator input system and a display system, the operator input system for receiving commands from an operator and the display system for displaying processed or unprocessed production data.

10. A data acquisition system as in claim 9 wherein the data collection device includes any one of or a combination of a digital or analog input/output device operatively connected to the central processor and wherein the digital and/or analog output devices are for operative connection to one or more production sensors or controls.

11. A data acquisition system as in claim 10 wherein the data collection device includes data storage memory operatively connected to the central processor for storing production data prior to uploading to the computer.

12. A data acquisition system as in claim 11 wherein the computer includes software having a central management module for managing the collection, analysis and reporting of production data from the data collection device.

13. A data acquisition system as in claim 12 wherein the central management module is operatively connected to a communication interface for sending and receiving data to and from the data collection device.

14. A data acquisition system as in claim 13 wherein the central management module includes a control module for sending control instructions to the production controls through the data collection device.

15. A data acquisition system for collecting data from at least one production well comprising:
a data collection device operatively connected to well production equipment for obtaining production data from a production well and for providing control instructions to the production equipment;
a central computer operatively connected to the data collection device for receiving production data from the data collection device and for sending control instructions to the production equipment via a wired or wireless interface wherein the central computer includes:
a central management module for managing the collection, analysis and reporting of production data from the data collection device;
a production data database;
a wired or wireless interface;
a reporting module for formatting reports from the production data database; and,
a graphical display module for displaying production data from the production data database

16. A method of collecting data from a production well comprising the steps of:
a) operatively connecting a data collection device to well production equipment at a well; and,
b) uploading production data from the data collection device via a wired or wireless link to a central computer.

17. A method as in claim 16 further comprising the step of sending a control instruction to the well production equipment from the central computer.
